(19) United States
(12) Patent Application Publication
(10) Pub. No.: US 2014/0243448 A1
(43) Pub. Date: Aug. 28, 2014

(54) TIRE WITH IMPROVED GRIP ON WET GROUND

(71) Applicants: MICHELIN RECHERCHE ET TECHNIQUE S.A., Granges-paccot (CH); COMPAGNIE GENERALE DES ETABLISSEMENTS MICHELIN, Clermont-Ferrand (FR)

(72) Inventors: Pierre Lesage, Clermont-Ferrand 9 (FR); Garance Lopitaux, Clermont-Ferrand 9 (FR); Didier Vasseur, Clermont-Ferrand 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/347,093

(22) PCT Filed: Sep. 26, 2012
(86) PCT No.: PCT/EP2012/068946

§ 371 Date: Mar. 25, 2014

(30) Foreign Application Priority Data
Sep. 26, 2011 (FR) 1158543

(51) Int. Cl. C08L 7/00

(52) U.S. Cl. CPC C08L 7/00
USPC 523/157

(57) ABSTRACT

A tire having an improved wet grip, in particular for a passenger vehicle, a van, or two-wheel vehicle, includes a tread of which includes a rubber composition. The rubber composition includes at least (phr meaning parts by weight per hundred parts of elastomer):
as a first diene elastomer, from 55 to 95 phr of natural rubber or synthetic polyisoprene;
as a second diene elastomer, from 5 to 45 phr of a polybutadiene or butadiene copolymer having a Tg greater than −70° C.;
as a reinforcing filler, from 60 to 90 phr of an inorganic filler;
as a plasticizer, more than 5 phr of a thermoplastic hydrocarbon resin exhibiting a Tg greater than 20° C.; and
optionally, from 0 to 20 phr of a plasticizing agent, which is a liquid at 23° C.

The field of the invention is that of rubber compositions for tyres, more particularly rubber compositions for treads of tyres of the passenger vehicle, two-wheel or van type.

A tyre tread has to meet, in a known way, a large number of often conflicting technical requirements, including a low rolling resistance, a high wear resistance, a high dry grip and a high wet grip.

These compromises in properties, in particular from the viewpoint of the rolling resistance and the wear resistance, could be improved in recent years with regard to energy-saving “Green Tyres”, intended in particular for passenger vehicles, by virtue especially of the use of novel low-hysteresis rubber compositions having the characteristic of being reinforced predominantly by reinforcing inorganic fillers, in particular by highly dispersible silicas, capable of rivalling, from the viewpoint of the reinforcing power, conventional tyre-grade carbon blacks.

The improvement in the wet grip properties without damaging, at the very least with minimal damage to, the other essential rolling properties, which are rolling resistance and wear resistance, is today a major preoccupation of tyre designers.

It is admittedly known that an increase in the content of inorganic filler can result in an improvement in wet grip. However, such an increase exhibits disadvantages: it is reflected in particular by penalizing the processability (carried out in the raw state) of the rubber compositions, without mentioning a risk of damage to other roiling properties, such as rolling resistance.

In point of fact, during their research studies, the Applicant Companies have discovered a rubber composition based on a blend of specific elastomers which makes it possible, without increasing the content of reinforcing inorganic filler and without damaging the other abovementioned rolling properties, to further improve the wet grip performance of Green Tyres.

Thus, a subject-matter of the invention is a tyre, the tread of which comprises a rubber composition comprising at least:
as first diene elastomer, from 55 to 95 phr of natural rubber or synthetic polyisoprene;
as second diene elastomer, from 5 to 45 phr of a polybutadiene or butadiene copolymer having a Tg of greater than −70° C.;
as reinforcing filler, from 60 to 90 phr of an inorganic filler;
as plasticizer, more than 5 phr of a thermoplastic hydrocarbon resin exhibiting a Tg of greater than 20° C. and optionally from 0 to 20 phr of a plasticizing agent which is liquid at 23° C.

The tyres of the invention are particularly intended to equip motor vehicles of passenger type, including 4×4 (four-wheel drive) vehicles and SUV (“Sport Utility Vehicles”) vehicles, vans and two-wheel vehicles (in particular motorcycles).

The invention and its advantages will be easily understood in the light of the description and implementational examples which follow.

### I. DETAILED DESCRIPTION OF THE INVENTION

In the present description, unless expressly indicated otherwise, all the percentages (%) shown are percentages by weight.

The abbreviation “phr” means parts by weight per hundred parts of elastomer or rubber (of the total of the elastomers, if several elastomers are present).

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

All the values for glass transition temperature “Tg” are measured in a known manner by DSC (Differential Scanning Calorimetry) according to Standard ASTM D3418 (1999).

The tyre of the invention thus has the essential characteristic that its tread comprises a rubber composition comprising at least a blend of two specific diene elastomers, a reinforcing inorganic filler and also a plasticizing system based on thermoplastic hydrocarbon resin, which components will be described in detail below.

### I-1 Blend of Diene Elastomers

The rubber composition of the tread of the tyre of the invention has the first essential characteristic of comprising at least a blend of two specific diene elastomers:
as first diene elastomer, from 55 to 95 phr of natural rubber or synthetic polyisoprene;
as second diene elastomer, from 5 to 45 phr of a polybutadiene or butadiene copolymer having a Tg of greater than −70° C.

The content of first diene elastomer is preferably within a range from 60 to 90 phr, in particular from 65 to 85 phr. Use is preferably made, among synthetic polyisoprenes, of polyisoprenes having a content (mol %) of cis-1,4- bonds of greater than 90%, more preferably still of greater than 98%.

The content of second diene elastomer is preferably within a range from 10 to 40 phr, in particular from 15 to 35 phr.

The following are suitable in particular as butadiene monomers: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, or an aryl-1,3-butadiene.

Butadiene copolymer is understood here to mean a copolymer of at least one butadiene monomer and of at least one other monomer (and, of course, also any mixture of such copolymers); in other words, the said copolymer based on butadiene comprises, by definition, at least butadiene units (resulting from the butadiene monomer) and units resulting from another monomer. Mention may in particular be made, as examples of preferred butadiene copolymers, of those selected from the group consisting of styrene/butadiene copolymers (SBRs), isoprene/butadiene copolymers (BIRs), isoprene/butadiene/styrene copolymers (SBIRs) and the mixtures of such copolymers.

The following are suitable in particular among polybutadienes or butadiene copolymers: polybutadienes having a content (mol %) of 1,2- units of between 4% and 80% or those having a content (mol %) of cis-1,4- units of greater than 80%, more particularly of greater than 90%, butadiene/isoprene copolymers and especially those having an isoprene content of between 5% and 90% by weight and a Tg of between −40° C. and −70° C., butadiene/styrene/isoprene copolymers having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2- units of the butadiene part of between 4% and 85%, a content (mol %) of trans-1,4- units of the butadiene part of between 6% and 80%, a content (mol %) of 1,2- plus 3,4- units of the isoprene part of between 5% and 70% and a content (mol %) of trans-1,4- units of the isoprene part of between 10% and 50%, and more generally any butadiene/styrene/isoprene copolymer having a Tg of between −2° C. and −7° C.

According to a particularly preferred embodiment, the butadiene copolymer is an SBR copolymer, it being possible for this SBR to be an emulsion SBR or ESBR (that is to say, prepared by emulsion polymerization), a solution SBR or SSBR (that is to say, prepared by solution polymerization) or a mixture of the two. More preferably still, the Tg of this SBR is greater than −50° C., more preferably greater than −30° C. and in particular greater than −25° C. A person skilled in the art knows how to modify the microstructure of a copolymer based on styrene and butadiene, in particular of an SBR, in order to increase and adjust its Tg, in particular by varying the contents of styrene, of 1,2- bonds or also of trans-1,4- bonds of the butadiene part.

The said butadiene copolymer, in particular copolymer of butadiene and styrene, can have any microstructure, which depends on the polymerization conditions used, in particular on the presence or absence of a modifying and/or randomizing agent and on the amounts of modifying and/or randomizing agent employed. It can, for example, be a block, statistical, sequential or microsequential copolymer and can be prepared in dispersion or in solution; it can be coupled and/or star-branched or else functionalized with a coupling and/or star-branching or functionalization agent, for example star-branched by tin. Mention may be made, for example, of silanol or polysiloxane functional groups having a silanol end (such as described, for example, in EP 0 778 311 or U.S. Pat. No. 6,013,718), alkoxysilane groups (such as described, for example, in EP 0 890 607, U.S. Pat. No. 5,977,238 or WO 2009/133068), carboxyl groups (such as described in U.S. Pat. No. 6,815,473 or U.S. 2006/0089445) or also polyether groups (such as described, for example, in U.S. Pat. No. 6,503,973).

According to a specific embodiment of the invention, use is made, for example, of a copolymer based on styrene and butadiene, in particular an SBR, which bears at least one (that is to say, one or more) SiOR functional group, R being hydrogen or a hydrocarbon radical preferably comprising from 1 to 4 carbon atoms, in particular a methyl or an ethyl. This SiOR functional group can be located at an end of the elastomer chain, even inside the elastomer chain or also as a pendant group along the elastomer chain; in the case where there are several SiOR functional groups borne by the copolymer, they can occupy one or the other of the configurations. Of course, the above copolymer, in particular SBR, can be a mixture of a first copolymer bearing a silanol functional group and of a second copolymer bearing an SiOR functional group (with R a hydrocarbon radical), in particular an alkoxysilane.

According to another specific embodiment, the copolymer based on styrene and butadiene, in particular SBR, whether or not it bears an SiOR functional group as described above, also bears at least one other functional group (different from the SiOR functional group), this other functional group being selected, for example, from the group consisting of epoxy, tin or amine functional groups, it being possible for the amine to be a primary, secondary or tertiary amine.

Diene elastomers other than those mentioned above might also be combined, in a minor amount, with the blend of diene elastomers described above.

### I-2. Reinforcing Filler

The rubber composition of the tread of the tyre in accordance with the invention has the other essential characteristic of comprising a reinforcing inorganic filler at a content of 60 to 90 phr, preferably of greater than 60 phr and less than 90 phr, more preferably still within a range from 65 to 85 phr.

The term “reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing, by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

Mineral fillers of the siliceous type, preferably silica (SiO₂) are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g, preferably from 30 to 400m²/g, in particular between 60 and 300 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in Application WO 03/16387. Mention will also be made, as reinforcing inorganic filler, of mineral fillers of the aluminous type, in particular alumina (Al₂O₃) or aluminium (oxide)hydroxides, or else reinforcing titanium oxides.

According to a preferred embodiment of the invention, the reinforcing inorganic filler comprises from 50% to 100% by weight of silica; in other words, the silica represents from 50% to 100% by weight of the reinforcing inorganic filler.

A person skilled in the art will understand that a reinforcing filler of another nature, in particular organic nature, such as carbon black, might be used as filler equivalent to the reinforcing inorganic filler described in the present section, provided that this reinforcing filler is covered with an inorganic layer, such as silica, or else comprises, as its surface, functional sites, in particular hydroxyls, requiring the use of a coupling agent in order to form the connection between the filler and the elastomer. Mention may be made, by way of example, for example, of carbon blacks for tyres, such as described, for example, in patent documents WO 96/37547 and WO 99/28380.

According to an advantageous embodiment, the composition of the tread can also comprise carbon black. The carbon black, when it is presents is preferably used at a content of less than 20 phr. more preferably of less than 10 phr (for example, between 0.5 and 20 phr, in particular between 2 and 10 phr). Within the intervals indicated, benefit is derived from the colouring properties (black pigmenting agent) and UV-stabilizing properties of the carbon blacks without, moreover, penalizing the performances introduced by the reinforcing inorganic filler.

In order to couple the reinforcing inorganic filler to the diene elastomer, use is made, in a known way, of a coupling agent (or bonding agent) intended to provide a satisfactory connection, of chemical and/or physical nature, between the inorganic filler (surface of its particles) and the diene elastomer. This coupling agent is at least bifunctional. Use is made in particular of at least bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or U.S. 2005/016651) and WO 03/002049 (or U.S. 2005/016650).

Particularly suitable, without the definition below being limiting, are silane polysulphides corresponding to the following general formula (I):

Z-A-Sₓ-A-Z, (I)

in which:
X is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, in particular C₁-C₄, alkylene, especially propylene);
the Z symbols, which are identical or different, correspond to one of the three formulae below:

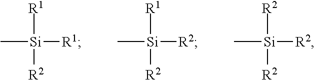

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cyoloalkoxyls, more preferably still a group selected from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S₂]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the abovementioned Patent Application WO 02/083782 (or U.S. Pat. No. 7,217,751).

Mention will in particular be made, as examples of coupling agents other than an alkoxysilane polysulphide, of bifunctional POSs (polyorganosiloxanes), or else of hydroxysilane polysulphides (R²═OH in the above formula I), such as described, for example, in Patent Applications WO 02/30939 (or U.S. Pat. No. 6,774,255), WO 02/31041 (or U.S. 2004/051210) and WO 2007/001550, or else of silanes or POSs bearing azodicarbonyl functional groups, such as described, for example, in Patent Applications WO 2006/125532, WO 2006/125533 and WO 2006/125534.

Mention will be made, as examples of other silane sulphides, for example, of the silanes bearing at least one thiol (—SH) functional group (referred to as mercaptosilanes) and/or at least one masked thiol functional group, such as described, for example, in Patents or Patent Applications U.S. Pat. No. 6,849,754, WO 99/09036, WO 2006/023815, WO 2007/098080, WO 2008/055986 and WO 2010/072685.

Of course, use might also be made of mixtures of the coupling agents described above, as described in particular in the abovementioned Application WO 2006/125534.

The content of coupling agent is preferably between 2 and 20 phr, more preferably between 3 and 15 phr.

### I-3. Plasticizing System

Another essential characteristic of the rubber composition of the tread of the tyre in accordance with the invention is to comprise, as plasticizer, more than 5 phr of a thermoplastic hydrocarbon resin exhibiting a Tg of greater than 20° C. and optionally from 0 to 20 phr of a plasticizing agent which is liquid at 23° C.

The designation “resin” is reserved in the present patent application, by definition, for a compound which is solid at ambient temperature (23° C.), in contrast to a liquid plasticizing agent, such as an oil.

Hydrocarbon resins are polymers well known to a person skilled in the art, essentially based on carbon and hydrogen but being able to comprise other types of atoms, which can be used in particular as plasticizing agents or tackifying agents in polymer matrices. They are by nature miscible (i.e., compatible) at the contents used with the polymer compositions for which they are intended, so as to act as true diluents. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). Their Tg is preferably greater than 25° C., in particular greater than 30° C. (generally between 30° C. and 100° C.).

In a known way, these hydrocarbon resins can also be described as thermoplastic resins in the sense that they soften when heated and can thus be moulded. They can also be defined by a softening point or temperature. The softening point of a hydrocarbon resin is generally greater by approximately 50 to 602 C. than its Tg value. The softening point is measured according to Standard ISO 4625 (Ring and Ball method). The microstructure (Mw, Mn and PI) is determined by size exclusion chromatography (SEC) as indicated below.

As a reminder, the SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a “Waters Alliance” chromatographic line according to the following conditions: elution solvent: tetrahydrofuran; temperature 35° C.; concentration 1 g/litre; flow rate: 1 ml/min; volume injected: 100 μl; Moore calibration with polystyrene standards; set of 3 “Waters” columns in series (“Styragel HR4E”, “Styragel HR1” and “Styragel HR 0.5”); detection by differential refractometer (for example, “Waters 2410”) which can be equipped with operating software (for example, “Waters Millenium”).

A Moore calibration is carried out with a series of commercial polystyrene standards having a low PI (less than 1.2), with known molar masses, covering the range of masses to be analysed. The weight-average molar mass (Mw), the number-average molar mass (Mn) and the polydispersity index (PI=Mw/Mn) are deduced from the data recorded (curve of distribution by mass of the molar masses). All the values for molar masses shown in the present patent application are thus relative to calibration curves produced with polystyrene standards.

According to a preferred embodiment of the invention, the hydrocarbon resin exhibits at least any one, more preferably all, of the following characteristics:
a Tg of greater than 25° C. (in particular between 30° C. and 100° C.), more preferably of greater than 30° C. (in particular between 30° C. and 95° C.);
a softening point of greater than 50° C. (in particular between 50° C. and 150° C.);
a number-average molar mass (Mn) of between 400 and 2000 g/mol preferably between 500 and 1500 g/mol;
a polydispersity index (PI) of less than 3, preferably of less than 2 (as a reminder: PI=Mw/Mn with Mw the weight-average molar mass).

Mention may be made, as examples of such hydrocarbon resins, of those selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of (D)CPD/vinylaromatic copolymer resins, (D)CPD/terpene copolymer resins, terpene/phenol copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, alpha-pinene, beta-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins and the mixtures of these resins.

All the above resins are well known to a person skilled in the art and are commercially available, for example sold by DRT under the name Dercolyte as regards polylimonene resins, sold by Neville Chemical Company under the name Super Nevtac, by Kolon under the name Hikorez or by Exxon Mobil under the name Escorez as regards C₅ fraction/styrene resins or C₅ fraction/C₉ fraction resins, or else by Struktol under the name 40 MS or 40 NS (mixtures of aromatic and/or aliphatic resins).

Preferably, the content of above hydrocarbon resin is between 5 and 60 phr, more preferably within a range from 10 to 30 phr.

Optionally, the plasticizing system additionally comprises from 0 to 20 phr of a liquid (at 23° C.) plasticizing agent, the role of which is to soften the matrix by diluting the elastomer and the reinforcing filler. The Tg of this liquid plasticizer is preferably less than −20° C., more preferably less than −40° C. The content of this liquid plasticizing agent is preferably within a range from 5 to 20 phr, more preferably from 5 to 15 phr.

Any extending oil, whether of aromatic or non-aromatic nature, any liquid plasticizing agent known for its plasticizing properties with regard to diene elastomers, can be used. At ambient temperature (23° C.), these plasticizers or these oils, which are more or less viscous, are liquids (that is to say, as a reminder, substances which have the ability to eventually take on the shape of their container), as opposed, in particular, to plasticizing hydrocarbon resins which are by nature solid at ambient temperature.

Liquid plasticizing agents selected from the group consisting of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils, mineral oils, vegetable oils, ether plasticizers, ester plasticizers, phosphate plasticizers, sulphonate plasticizers and the mixtures of these compounds are particularly suitable. According to a more preferred embodiment, the liquid plasticizing agent is selected from the group consisting of MES oils, TDAE oils, naphthenic oils, vegetable oils and the mixtures of these oils.

According to a preferred embodiment of the invention, the liquid plasticizer, in particular petroleum oil, is of the non-aromatic type. A liquid plasticizer is described as non-aromatic when it exhibits a content of polycyclic aromatic compounds, determined with the extract in DMSO according to the IP 346 method, of less than 3% by weight, with respect to the total weight of the plasticizer. Therefore, use may preferably be made of a liquid plasticizing agent selected from the group consisting of MES oils, TDAE oils, naphthenic oils (of low or high viscosity, in particular hydrogenated or non-hydrogenated), paraffinic oils and the mixtures of these oils. RAE oils, TRAE oils and SRAE oils or the mixtures of these oils, which contain low contents of polycyclic compounds, are also suitable as petroleum oil.

According to another specific embodiment, the liquid plasticizer is a terpene derivative; mention may in particular be made, as example, of the product Dimarone from Yasuhara.

The liquid polymers resulting from the polymerization of olefins or dienes, such as, for example, those selected from the group consisting of polybutenes, polydienes, in particular polybutadienes, polyisoprenes, copolymers of butadiene and isoprene, copolymers of butadiene or isoprene and styrene, and the mixtures of these liquid polymers, are also suitable. The number-average molar mass of such liquid polymers is preferably within a range extending from 500 g/mol to 50 000 g/mol, more preferably from 1000 g/mol to 10 000 g/mol. Mention may in particular be made, by way of example, of the Ricon products from Sartomer.

According to a particularly preferred embodiment of the invention, the liquid plasticizer is a vegetable oil. Use is preferably made of an oil selected from the group consisting of linseed, safflower, soybean, maize, cottonseed, rapeseed, castor, tung, pine, sunflower, palm, olive, coconut, peanut and grapeseed oils, and the mixtures of these oils, in particular a sunflower oil. This vegetable oil, in particular sunflower oil, is more preferably an oil rich in oleic acid, that is to say that the fatty acid (or all of the fatty acids, if several are present) from which it derives comprises oleic acid according to a fraction by weight at least equal to 60%, more preferably at least equal to 70%, in particular equal to or greater than 80%.

According to a particularly preferred embodiment, the total content of hydrocarbon resin and liquid plasticizing agent is within a range from 10 to 45 phr, preferably within a range from 10 to 40 phr, in particular from 15 to 35 phr.

According to another particularly preferred embodiment, the ratio by weight of total plasticizer (that is to say, hydrocarbon plasticizing resin plus optional liquid plasticizer) to the weight of reinforcing inorganic filler is between 25% and 45%, more preferably within a range extending from 30% to 40%.

### I-4. Various Additives

The rubber compositions of the treads of the tyres in accordance with the invention can also comprise all or a portion of the usual additives for elastomer compositions intended for the manufacture of treads for tyres, in particular tyres for passenger vehicles, fillers other than those mentioned above, for example non-reinforcing fillers, such as chalk, pigments, protective agents, such as antiozone waxes, chemical antiozonants or antioxidants, reinforcing resins (such as resorcinol or bismaleimide), methylene acceptors (for example, phenolic novolak resin) or methylene donors (for example, HMT or H3M), as described, for example, in Application WO 02/10269, a crosslinking system based either on sulphur, or on sulphur donors and/or on peroxide and/or on bismaleimides, vulcanization accelerators or vulcanization retarders, or vulcanization activators.

These compositions can also comprise coupling activators, agents for covering the inorganic filler or more generally processing aids capable, in a known way, by virtue of an improvement in the dispersion of the filler in the rubber matrix and of a lowering of the viscosity of the compositions, of improving their ability to be processed in the raw state; these agents are, for example, hydrolysable silanes, such as alkylalkoxysilanes, polyols, polyethers, amines, or hydroxylated or hydrolysable polyorganosiloxanes.

### I-5. Preparation of the Rubber Compositions

The compositions used in the treads of the tyres of the invention can be manufactured in appropriate mixers, using two successive phases of preparation well known to a person skilled in the art: a first phase of thermomechanical working or kneading (“non-productive” phase) at high temperature, up to a maximum temperature of between 110° C. and 190° C., preferably between 130° C. and 180° C., followed by a second phase of mechanical working (“productive” phase) down to a lower temperature, typically of less than 110° C., for example between 40° C. and 100° C., during which finishing phase the crosslinking system is incorporated.

The process for preparing such compositions comprises, for example, the following stages:
thermomechanically kneading (for example in one or more goes) the diene elastomers with the reinforcing inorganic filler, the coupling agent, if appropriate the carbon black, and the plasticizing system, until a maximum temperature of between 110° C. and 190° C. is reached (“non-productive” phase);
cooling the combined mixture to a temperature of less than 100° C.;
subsequently incorporating, during a second stage (“productive” stage), a crosslinking system;
kneading everything up to a maximum temperature of less than 110° C.

By way of example, the non-productive phase is carried out in a single thermomechanical stage during which, in a first step, all the base constituents (the diene elastomers, the plasticizing system, the reinforcing inorganic filler and the coupling agent) are introduced into an appropriate mixer, such as a standard internal mixer, followed, in a second step, for example after kneading for one to two minutes, by the other additives, optional additional agents for covering the filler or optional additional processing aids, with the exception of the crosslinking system. The total duration of the kneading, in this non-productive phase, is preferably between 1 and 15 min.

After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

The crosslinking system proper is preferably based on sulphur and on a primary vulcanization accelerator, in particular on an accelerator of the sulphenamide type. Various known secondary vulcanization accelerators or vulcanization activators, such as zinc oxide, stearic acid, guanidine derivatives (in particular diphenylguanidine), and the like, come to be added to this vulcanization system, being incorporated during the first non-productive phase and/or during the productive phase. The sulphur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of diene elastomers in the presence of sulphur, in particular accelerators of the thiazole type and their derivatives and accelerators of the thiuram and zinc dithiocarbamate types. These accelerators are more preferably selected from the group consisting of 2-mercaptobenzothiazyl disulphide (abbreviated to “MBTS”), N-cyclohexyl-2-benzothiazolesulphenamide (abbreviated to “DCBS”), N,N-dicyclohexyl-2-benzothiazolesulphenamide (abbreviated to “DCBS”), N-(tert-butyl)-2-benzothiazolesulphenamide (abbreviated to “TBBS”), N-(tert-butyl)-2-benzothiazolesulphenamide (abbreviated to “TBSI”), zinc dibenzyldithiocarbamate (abbreviated to “ZBEC”) and the mixtures of these compounds. Preferably, a primary accelerator of the sulphenamide type is used.

The final composition thus obtained can subsequently be calendered, for example in the form of a sheet or of a plaque, in particular for laboratory characterization, or also extruded, for example to form a rubber profiled element used in the manufacture of a tyre tread, in particular for a passenger vehicle.

The invention also applies to the cases where the rubber compositions described above form only a portion of treads of the composite or hybrid type, in particular those consisting of two radially superimposed layers of different formulations, both being patterned and intended to come into contact with the road when the tyre is rolling, during the life of the latter. The base part of the formulation described above will then be able to constitute the radially outer layer of the tread intended to come into contact with the ground from the moment when the new tyre starts rolling, or on the other hand its radially inner layer intended to come into contact with the ground at a later stage.

According to a preferred embodiment, the Shore A hardness of the rubber composition according to the invention is within a range extending from 60 to 75, more preferably from 65 to 75; the Shore A hardness of the compositions after curing is assessed in accordance with Standard ASTM D 2240-86.

The invention relates to the tyres described above, both in the raw state (that is to say, before curing) and in the cured state (that is to say, after crosslinking or vulcanization).

### II. EXAMPLES OF THE IMPLEMENTATION OF THE INVENTION

### II.1—Preparation of the Compositions

The following tests are carried out in the following way: the elastomers, the silica, the coupling agent, the plasticizers and also the various other ingredients, with the exception of the vulcanization system, are successively introduced into an internal mixer (final degree of filling: approximately 70% by volume), the initial vessel temperature of which is approximately 60° C. Thermomechanical working (non-productive phase) is then carried out in one stage, which lasts in total 5 min, until a maximum “dropping” temperature of 165° C. is reached. The mixture thus obtained is recovered and cooled and then sulphur and an accelerator of sulphenamide type are incorporated on a mixer (homofinisher) at 23° C., everything being mixed (productive phase) for an appropriate time (for example between 5 and 12 min).

The compositions thus obtained are subsequently calendered, either in the form of plaques or thin sheets of rubber, for the measurement of their physical or mechanical properties, or extruded in the form of treads of tyres for a passenger vehicle.

### II.2—Rubber Tests

The rubber compositions thus prepared are subsequently characterized, before and after curing, as indicated below.
Mooney plasticity: use is made of an oscillating consistometer as described in French Standard NF T 43-003 (November 1980). The Mooney plasticity measurement is carried out according to the following principle: the composition in the raw state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney unit” (MU, with 1 MU=0.83 newton.metre);
tensile tests: unless otherwise indicated, they are carried out in accordance with French Standard NF T 46-002 of September 1988. The nominal secant moduli (or apparent stresses, in MPa) are measured in second elongation (i.e. after an accommodation cycle at the extension rate provided for the measurement itself) at 10% elongation (denoted M10) and 100% elongation (denoted M100). All these tensile measurements are carried out under the standard conditions of temperature (23±2° C.) and hygrometry (50±5% relative humidity), according to French Standard NF T 40-101 (December 1979);

Shore A hardness: the Shore A hardness of the compositions after curing is assessed in accordance with Standard ASTM D 2240-86.

For the requirements of these tests, two rubber compositions (denoted C-0 and C-1) were prepared, the formulations of which are given in the appended Table 1, the contents of the different products being expressed in phr (parts by weight per hundred parts of total elastomer).

The control composition (C-0) is a conventional composition for a “Green Tyre” having a low roiling resistance, with a formulation well-known to a person skilled in the art, based on a blend of two SBRs, comprising 90 phr of reinforcing inorganic filler (silica), a coupling agent and, as plasticizing system, on the one hand 20 phr of liquid plasticizing agent (TDAE oil) and, on the other hand, 20 phr of thermoplastic plasticizing resin; in this control composition, the plasticizer total is thus equal to 40 phr.

The composition according to the invention (C-1) differs essentially from the control composition (C-0) on the one hand by a particularly high content of NR (80 phr of NR instead of 80 phr of SBR) and a reduced content of inorganic filler (silica) within the recommended range (more than 60 phr and less than 90 phr). In addition, the total content of total plasticizer (resin and liquid plasticizer) was reduced in the composition C-1 in order to compensate, at least in part, for the loss in stiffness due to the decrease in the content of reinforcing filler.

The rubber properties before and after curing (30 min at 150° C.) are given in Table 2; the vulcanization system consists of sulphur and sulphenamide. It is noted that the composition according to the invention advantageously exhibits a viscosity in the raw state which is very markedly reduced in comparison with the control composition, evidence of an improved processability (ability to be processed in the raw state), and, moreover, equivalent moduli.

### II.3—Running Tests on the Tyres

The two compositions above (C-0 and C-1) are subsequently used as treads for radial carcass passenger vehicle tyres, respectively denoted T-0 (control tyres) and T-1 (tyres according to the invention), with dimensions of 225/55R16, which are conventionally manufactured and which are in all respects identical apart from the constituent rubber compositions of their treads. The tyres are fitted, at the front and at the rear, under nominal inflation pressure, to a motor vehicle of the “BMW” make, “530” model, equipped with an ABS system.

The tyres are subsequently subjected to a braking test on wet ground (at 10° C.) which consists in measuring the distance needed to go from 80 km/h to 10 km/h during sudden braking on sprayed ground (bituminous concrete). A value greater than that of the control, arbitrarily set at 100, indicates an improved result, that is to say a shorter braking distance.

The rolling resistance is also measured on a rolling drum (at 23° C.), according to the ISO 87-67 (1992) method. A value greater than that of the control, arbitrarily set at 100, indicates an improved result, that is to say a lower rolling resistance.

Finally, the tyres are also subjected to actual on-road running (winter temperature, less than 10° C.) until the wear due to the running reaches the wear indicators positioned in the grooves of the tread. A value greater than that of the control, arbitrarily set at 100, indicates an improved result, that is to say a greater mileage travelled.

The combined results obtained are summarized in the appended Table 3.

It is first of all found that the braking performance on wet ground is markedly improved, by approximately 10%: such a result corresponds, in this test, to a braking distance shortened by approximately 4 metres, a result quite noteworthy for a person skilled in the art.

In addition, it is noted, unexpectedly, that not only are the rolling resistance and the wear resistance not damaged but that they are even improved, in a highly significant way, in the case of the tyres in accordance with the invention.

TABLE 1

| Composition No. | C-0 | C-1 |
|---|---|---|
| SBR (1) | 40 | 20 |
| SBR (2) | 60 | — |
| NR (3) | — | 80 |
| Silica (4) | 90 | 75 |
| Coupling agent (5) | 7.2 | 6.0 |
| Carbon black (6) | 4 | 4 |
| Plasticizing resin (7) | 20 | 15 |
| Liquid plasticizer (8) | 20 | 12 |
| Total plasticizer | 40 | 27 |
| Stearic acid | 2 | 2 |
| Antiozone wax | 2 | 2 |
| Antioxidant (9) | 2.5 | 2.5 |
| DPG (10) | 1.8 | 1.8 |
| ZnO | 1.2 | 1.2 |
| Accelerator (11) | 2.0 | 2.0 |
| Sulphur | 1.2 | 1.2 |

(1) Solution SBR with 41% of styrene units and 24% of 1,2- units of the butadiene part (Tg = −28° C.);
(2) Solution SBR with 29% of styrene units and 78% of trans units of the butadiene part (Tg = −50° C.);
(3) Natural rubber;
(4) Zeosil 1165 MP silica from Rhodia (HDS type);
(5) TESPT coupling agent (Si69 from Evonik);
(6) ASTM grade N234 (Cabot);
(7) C₅/C₉ Resin (Escorez ECR-373 from Exxon Mobil);
(8) TDAE oil (Vivatec 500 from Klaus Dahleke) or sunflower oil (Lubrirob Tod 1880 from Novance);
(9) N-(1,3-Dimethylbutyl-N′-phenyl-p-phenylenediamine (Flexsys);
(10) Diphenylguanidine (Perkacit DPG from Flexsys);
(11) N-Cyclohexyl-2-benzothiazolesulphenamide (Santocure CBS from Flexsys).

TABLE 2

| Composition No.: | C-0 | C-1 |
|---|---|---|
| Properties before curing: | | |
| Mooney (MU) | 63 | 39 |
| Properties after curing: | | |
| Shore A | 70 | 65 |
| M10 | 6.5 | 5.2 |
| M100 | 2.0 | 1.9 |

TABLE 3

| Tyre | T-0 | T-1 |
|---|---|---|
| Wet grip | 100 | 108 |
| Rolling resistance | 100 | 109 |
| Wear resistance | 100 | 104 |

1-16. (canceled)

17. A tire comprising a tread including a rubber composition that includes:
55 to 95 phr of natural rubber or synthetic polyisoprene, as a first diene elastomer;
5 to 45 phr of a polybutadiene or butadiene copolymer having a Tg greater than −70° C., as a second diene elastomer;
60 to 90 phr of a reinforcing inorganic filler;
more than 5 phr of a thermoplastic hydrocarbon resin exhibiting a Tg greater than 20°l C., as a plasticizer; and
0 to 20 phr of a plasticizing agent, which is a liquid at 23° C.

18. The tire according to claim 17, wherein the rubber composition includes from 60 to 90 phr of the first diene elastomer.

19. The tire according to claim 18, wherein the rubber composition includes from 10 to 40 phr of the second diene elastomer.

20. The tire according to claim 17, wherein the second diene elastomer is a styrene/butadiene copolymer.

21. The tire according to claim 20, wherein the styrene/butadiene copolymer has a Tg greater than −50° C.

22. The tire according to claim 21, wherein the styrene/butadiene copolymer has a Tg greater than −30° C.

23. The tire according to claim 17, wherein the rubber composition includes from 65 to 85 phr of the reinforcing inorganic filler.

24. The tire according to claim 17, wherein the rubber composition includes between 5 and 60 phr of the thermoplastic hydrocarbon resin.

25. The tire according to claim 24, wherein the rubber composition includes from 10 to 30 phr of the thermoplastic hydrocarbon resin.

26. The tire according to claim 17, wherein the rubber composition includes from 5 to 20 phr of the plasticizing agent.

27. The tire according to claim 17, wherein, in the rubber composition, a total content of the thermoplastic hydrocarbon resin and the plasticizing agent is within a range from 10 to 45 phr.

28. The tire according to claim 27, wherein the total content is within a range from 10 to 40 phr.

29. The tire according to claim 17, wherein the reinforcing inorganic filler includes from 50% to 100% by weight of silica.

30. The tire according to claim 17, wherein the thermoplastic hydrocarbon resin is selected from a group consisting of: cyclopentadiene homopolymer or copolymer resins, dicyclopentadiene homopolymer or copolymer resins, terpene homopolymer or copolymer resins, C5 fraction homopolymer or copolymer resins, C9 fraction homopolymer or copolymer resins, α-methylstyrene homopolymer or copolymer resins, and mixtures thereof.

31. The tire according to claim 17, wherein the plasticizing agent is selected from a group consisting of: liquid diene polymers, polyolefin oils, naphthenic oils, paraffinic oils, distillate aromatic extracts oils, medium extracted solvates oils, treated distillate aromatic extracts oils, residual aromatic extracts oils, treated residual aromatic extracts oils, safety residual aromatic extracts oils, mineral oils, vegetable oils, ether plasticizers, ester plasticizers, phosphate plasticizers, sulphonate plasticizers, and mixtures thereof.

32. The tire according to claim 31, wherein the plasticizing agent is selected from a group consisting of: medium extracted solvates oils, treated distillate aromatic extracts oils, naphthenic oils, vegetable oils, and mixtures thereof.

33. The tire according to claim 32, wherein the plasticizing agent is a vegetable oil.

34. The tire according to claim 33, wherein the plasticizing agent is a sunflower oil.

35. The tire according to claim 17, wherein a ratio by weight of the thermoplastic hydrocarbon resin and the plasticizing agent to the reinforcing inorganic filler is between 25% and 45%.

36. The tire according to claim 35, wherein the ratio is within a range from 30% to 40%.

37. The tire according to claim 17, wherein the tire is a passenger-vehicle tire, a van tire, or a tire for a two-wheel vehicle.
